(19) United States
(12) Patent Application Publication
(10) Pub. No.: US 2012/0285709 A1
(43) Pub. Date: Nov. 15, 2012

(54) Fire Hose Deployment Device

(75) Inventors: John E. McLoughlin, Hauppauge, NY (US); Neocles G. Athanasiades, E. Setauket, NY (US); Kiam Meng Toh, Hauppauge, NY (US)

(73) Assignee: JNT Link, LLC, Nesconset, NY (US)

(21) Appl. No.: 13/104,330

(22) Filed: May 10, 2011

(51) Int. Cl. A62C 27/00

(52) U.S. Cl. 169/52

(57) ABSTRACT

A fire hose deployment device for a firefighting robotic vehicle comprises a wagon body having a bottom and two generally vertical sides, a front tongue coupled to the wagon body and hitched to a rear hitch of the robotic vehicle. The wagon body has left and right wheels coupled to the wagon near the rear of the wagon body, and the wagon body carries a fire hose with a first end coupled to a nozzle on the robotic vehicle and a second end coupled to a fluid source.

### FIELD

The present disclosure relates to a fire hose deployment device for a firefighting robotic vehicle.

### BACKGROUND

Firefighting is a highly dangerous task that subjects firefighters to many hazards, such as toxic smoke and fumes, high intensity heat, obstructed paths, collapsing structures, and falling objects. Fighting wild brush or forest fires presents yet another set of difficulties and challenges. To minimize risks to human lives, robotic vehicles have been envisioned as firefighting vehicles that can be remotely controlled and sent into hazardous situations to put out fires or perform other related tasks.

### SUMMARY

A fire hose deployment device for a firefighting robotic vehicle is envisioned.

A fire hose deployment device for a firefighting robotic vehicle comprises a wagon body having a bottom and two generally vertical sides, a front tongue coupled to the wagon body and hitched to a rear hitch of the robotic vehicle. The wagon body has left and right wheels coupled to the wagon near the rear of the wagon body, and the wagon body carries a fire hose with a first end coupled to a nozzle on the robotic vehicle and a second end coupled to a fluid source.

A fire hose deployment wagon comprises a body, a front tongue hitched to a rear hitch of a firefighting robotic vehicle, and left and right wheels coupled to the body near the rear of the body. The wagon body accommodates a fire hose arranged orderly therein having a first end coupled to a master stream nozzle coupled to the firefighting robotic vehicle and a second end coupled to a fluid source.

A remote firefighting device comprises a robotic vehicle and a hose deployment wagon. The robotic vehicle comprises a master stream nozzle and a rear hitch. The fire hose deployment wagon comprises a body, a front tongue hitched to a rear hitch of the firefighting robotic vehicle, and left and right wheels coupled to the body near the rear of the body. The wagon body accommodates a fire hose arranged orderly therein having a first end coupled to a master stream nozzle coupled to the firefighting robotic vehicle and a second end coupled to a fluid source.

### BRIEF DESCRIPTION OF THE DRAWINGS

FIG. 1 is a side elevational view of an exemplary embodiment of a fire hose deployment device for a firefighting robotic vehicle; and

FIG. 2 is a perspective view of an exemplary embodiment of a fire hose deployment device for a firefighting robotic vehicle.

### DETAILED DESCRIPTION

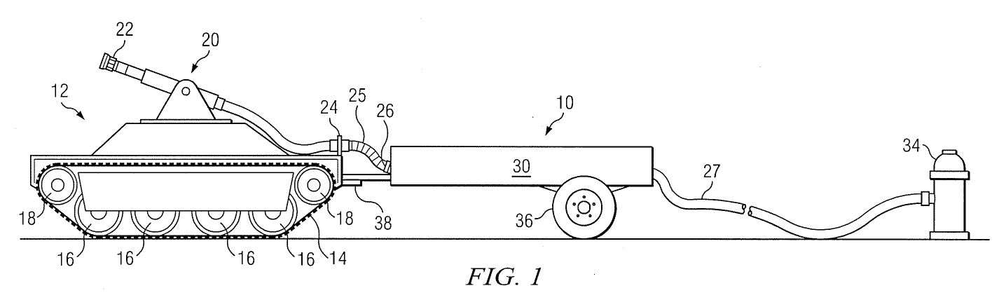

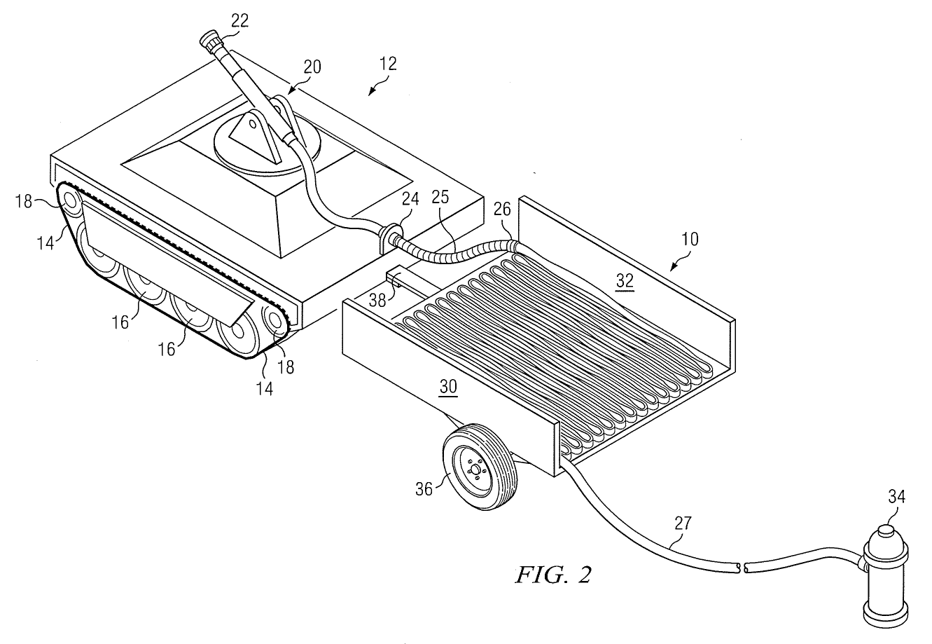

FIGS. 1 and 2 are side elevational and perspective views of an exemplary embodiment of a fire hose deployment device 10 for a firefighting robotic vehicle 12. The robotic vehicle 12 includes a self-propelling system (not shown) powered by gas, diesel, electricity, or another form of energy that enables the robotic vehicle to travel and function according to remote control commands. Accordingly, the robotic vehicle 12 may include a fuel tank or batteries for power source. As shown, the robotic vehicle 12 is equipped with an undercarriage having a left and right track assemblies 14 and respective wheels 16 and sprockets 18. The track assemblies 14 enable the robotic vehicle 12 to travel on rugged terrain and over obstacles. The tracks may be constructed of metal or other suitable materials. The robotic vehicle 12 may turn, reverse, and proceed by operating the track assemblies 14.

The robotic vehicle 12 is equipped with a computer such as a microprocessor or microcontroller (not shown) executing software code and coupled to a communications interface and antenna (not shown) that are operable to receive remote radio control signals from a remote controller (not shown). Alternatively, the robotic vehicle 12 may utilize wired communication with the controller/user.

The robotic vehicle 12 further includes a turret 20 coupled to a nozzle 22, which is preferably a master stream nozzle. The turret 20 is preferably operable to pivot vertically with an 180 degree range, and to rotate horizontally with an 360 degree range, so that the master stream nozzle 22 can be easily manipulated to accurately direct a liquid at the fire. The master stream nozzle 22 is a multi-purpose nozzle that may be remotely controlled to release water, fog, and foam in a number of flow configurations and pressures. For example, the master stream nozzle 22 may switch from a straight stream to fog, to a piercing nozzle. The master stream nozzle 22 may be further configured to enable a water-powered drill.

The master stream nozzle 22 is further coupled to a hose coupling 24 which enables it to be connected to a first hose segment 25. The first hose segment 25 is a section of hose that is flexible and does not kink easily. The hose segment 25 is coupled to a flat fire hose 27 via an adaptor 26. The fire hose 27 is carried in a hose deployment device 10 in the form of a cart or wagon with a generally flat bottom, two generally vertical sides 30 and 32, and a tongue 38 coupled to a hitch of the robotic vehicle 12. The wagon body is preferably constructed of sturdy and fire retardant materials such as metal, composites, and other suitable materials. As shown in FIG. 2, the fire hose 27 is laid in the body of the wagon in an orderly manner with the other end coupled to a fluid (water or chemical) source 34, such as a hydrant, tank, or pump. The length of the hose 27 is largely dependent on the desired distance to be traveled by the robotic vehicle. To facilitate the deployment of the fire hose 27, the front and back of the wagon are preferably open. The top of the wagon body may be open to facilitate the loading of the hose into the wagon, or a hinged lid (not shown) may be used to keep debris and objects from falling on the hose. The weight of the wagon and the fire hose 27 is supported by two tires or wheels 36 positioned near the rear of the wagon so that the combined weight impinges downwardly on the tongue and hitch to provide additional traction to the robotic vehicle track assemblies 14 on the ground.

In operation, as the robotic vehicle 12 travels away from the fluid source 34, the hose 27 deploys and is released from the wagon in an orderly manner. When the robotic vehicle reaches the limit of travel generally determined by the length of the fire hose 27, the controller may remotely operate the turret 20 and the master stream nozzle 22 to direct and dispense water and/or a chemical solution in a variety of pressures and configurations as needed. The flexible hose segment 25 is adapted to maintain the passageway of the fire hose without kinks or bends even while the robotic vehicle and the wagon are oriented at odd angles. This prevents the obstruction of the flow of the water or chemicals in the fire hose 27.

The features of the present invention which are believed to be novel are set forth below with particularity in the appended claims. However, modifications, variations, and changes to the exemplary embodiments described above will be apparent to those skilled in the art, and the fire hose deployment device described herein thus encompasses such modifications, variations, and changes and are not limited to the specific embodiments described herein.

What is claimed is:

1. A fire hose deployment device for a firefighting robotic vehicle comprising:
a wagon body having a bottom and two generally vertical sides;
a front tongue coupled to the wagon body and hitched to a rear hitch of the robotic vehicle;
left and right wheels coupled to the wagon near the rear of the wagon body; and
the wagon body carrying a fire hose with a first end coupled to a nozzle on the robotic vehicle and a second end coupled to a fluid source.

2. The hose deployment device of claim 1 wherein the wagon body comprises open front and back ends.

3. The hose deployment device of claim 1 wherein the wagon body comprises a lid covering the top of the wagon body.

4. A fire hose deployment wagon comprising:
a body;
a front tongue hitched to a rear hitch of a firefighting robotic vehicle;
left and right wheels coupled to the body near the rear of the body;
the body accommodating a fire hose arranged orderly therein having a first end coupled to a master stream nozzle coupled to the firefighting robotic vehicle and a second end coupled to a fluid source.

5. The fire hose deployment wagon of claim 4, wherein the body further comprises left and right generally vertical sides.

6. A remote firefighting device, comprising:
a remotely-controllable robotic vehicle comprising:
a master stream nozzle;
a rear hitch;
a wagon comprising:
a body;
a front tongue coupled to the body and hitched to the rear hitch of the robotic vehicle;
left and right wheels coupled to the body near the rear of the body;
the body accommodating a fire hose arranged orderly therein having a first end coupled to the master stream nozzle of the robotic vehicle and a second end coupled to a fluid source.

7. The remote firefighting device of claim 6, wherein the body further comprises left and right generally vertical sides, and open front and back ends.

8. The remote firefighting device of claim 6, wherein the body further comprises a lid covering the top of the body.
